(19) United States
(12) Patent Application Publication
(10) Pub. No.: US 2026/0304339 A1
(43) Pub. Date: Oct. 1, 2026

(54) METHOD AND APPARATUS FOR DATA PLANE CONFIGURATION AND MANAGEMENT IN WIRELESS NETWORKS

(71) Applicant: InterDigital Patent Holdings, Inc., Wilmington, DE (US)

(72) Inventors: Anuj Sethi, Ottawa (CA); Saad Ahmad, Montreal (CA); Taimoor Abbas, Sainte-Julie (CA); Michael Starsinic, Newtown, PA (US); Ulises Olvera-Hernandez, Saint-Lazare (CA); Achref Methenni, Montreal (CA)

(73) Assignee: InterDigital Patent Holdings, Inc., Wilmington, DE (US)

(21) Appl. No.: 19/092,653

(22) Filed: Mar. 27, 2025

(51) Int. Cl. H04W 60/00; H04W 48/18; H04W 76/11; H04W 76/12

(52) U.S. Cl. CPC H04W 60/00; H04W 48/18; H04W 76/11; H04W 76/12

(57) ABSTRACT

Various methods, systems, and apparatuses provide supporting, establishing, and/or managing a data plane (DP) in a network. The DP carries data between a wireless transmit receive unit (WTRU) and one or more core network functions (NFs) in a core network (CN). In that, one or more functionalities for establishing and/or managing one or more DP sessions may be configured in a new NF in the CN and/or an existing NF may be enhanced to provide the one or more functionalities related to the DP. The DP may facilitate transfer of data within the network when a data consumer and/or a data generator are within the network. An access and mobility management (AMF) and/or an enhanced AMF (eAMF) may facilitate the one or more DP sessions between the WTRU and the one or more existing (e.g., enhanced) core NFs and/or the new NF.

### BACKGROUND

Typically, in wireless networks such as fifth generation (5G) networks and/or sixth generation (6G) networks, there are two primary planes, viz., a control plane (CP) and a user plane (UP), for control and data signals to flow through devices (e.g., wireless transmit/receive unit (WTRU) and/or user equipment (UE) etc.) and core network functions (NFs). The CP is used for signaling between the devices and the core NFs. The UP handles actual user data traffic between the devices and external data networks (DNs). There is a need for a technique for exchanging data within a 5G and/or 6G networks that can provide efficient routing, reduce latency, and/or provide more security for data transfer within the 5G and/or 6G networks.

### SUMMARY

In one or more embodiments of the present disclosure, a method for establishing a data plane (DP) session is provided. The method comprises receiving, from a wireless transmit/receive unit (WTRU), a registration request indicative of a DP support capability. The method comprises selecting a network function (NF) based on the registration request. The method comprises transmitting, to the NF, a first DP session request including a WTRU identifier (ID) associated with the WTRU and a DP session ID associated with a DP session. The method comprises receiving, from the NF, a first DP session response including core network (CN) tunnel information. The method comprises transmitting, to a radio access network (RAN) node, a second DP session request including the CN tunnel information. The method comprises receiving, from the RAN node, a second DP session response including an access network (AN) tunnel information. The method comprises forwarding the AN tunnel information to the NF.

In an embodiment, determining the establishment of a DP session is based on one or more policies.

In an embodiment, the method further comprises generating the DP session ID based on the registration request.

In an embodiment, the registration request is indicative of one or more of: a DP message, a data session management message (DSM), or one or more services requested by the WTRU.

In an embodiment, the method further comprises transmitting, to the WTRU, a registration accept message indicative of establishing the DP session.

In an embodiment, the CN tunnel information includes a CN address of a tunnel between the NF and the RAN node.

In an embodiment, the AN tunnel information includes a tunnel endpoint identifier associated with the RAN node.

In an embodiment, the method further comprises determining, based on DP session management subscription data associated with the WTRU, whether the registration request is valid, wherein the NF is selected on a condition that the registration request is valid. The method further comprises, on a condition that the registration request is not valid, transmitting a registration reject message to the WTRU.

In an embodiment, the method further comprises receiving the DP session management subscription data from the WTRU or a second NF.

In an embodiment, the method is performed by an access and mobility management function (AMF).

In one or more embodiments, an apparatus comprising a transceiver and a processor is provided. The transceiver and the processor are configured to receive, from a WTRU, a registration request indicative of a DP support capability. The transceiver and the processor are configured to select a NF based on the registration request. The transceiver and the processor are configured to transmit, to the NF, a first DP session request including a WTRU ID associated with the WTRU and a DP session ID associated with a DP session. The transceiver and the processor are configured to receive, from the NF, a first DP session response including CN tunnel information. The transceiver and the processor are configured to transmit, to a RAN node, a second DP session request including the CN tunnel information. The transceiver and the processor are configured to receive, from the RAN node, a second DP session response including an AN tunnel information. The transceiver and the processor are configured to forward the AN tunnel information to the NF.

In an embodiment, determining the establishment of a DP session is based on one or more policies.

In an embodiment, the transceiver and the processor are further configured to generate the DP session ID based on the registration request.

In an embodiment, the registration request is indicative of one or more of: a DP message, a DSM, or one or more services requested by the WTRU.

In an embodiment, the transceiver and the processor are further configured to transmit, to the WTRU, a registration accept message indicative of establishing the DP session.

In an embodiment, the CN tunnel information includes a CN address of a tunnel between the NF and the RAN node.

In an embodiment, the AN tunnel information includes a tunnel endpoint identifier associated with the RAN node.

In an embodiment, the transceiver and the processor are further configured to determine, based on DP session management subscription data associated with the WTRU, whether the registration request is valid, wherein the NF is selected on a condition that the registration request is valid. The transceiver and the processor are configured to, on a condition that the registration request is not valid, transmit a registration reject message to the WTRU.

In an embodiment, the transceiver and the processor are further configured to receive the DP session management subscription data from the WTRU or a second NF.

In an embodiment, the apparatus is an AMF.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates a simplified diagram of an example fifth generation (5G) system architecture showing a subset of a plurality of network functions (NFs) in a 5G core according to one or more embodiments;

FIG. 3 illustrates an example control plane stack between a WTRU and an access and mobility management function (AMF) according to one or more embodiments;

FIG. 4 illustrates an example data plane (DP) in an example 5G network according to one or more embodiments;

FIGS. 5A-5B are a flow diagram illustrating an example DP session establishment procedure according to one or more embodiments; and

FIG. 6 is a flowchart illustrating an example process of establishing a DP session according to one or more embodiments.

### DETAILED DESCRIPTION

The following non-exhaustive list of abbreviations in Table 1 may be used in this disclosure:

TABLE 1

| | |
|---|---|
| 6GS | 6G System |
| 6GMM | 6G Mobility Management |
| 6GSM | 6G Session Management |
| 6GS | 6G System |
| 5GS | 5G System |
| 6GC | 6G Core |
| 5GC | 5G Core |
| AF | Application Function |
| AMF | Access and Mobility Management Function |
| CM | Connection Management |
| DNN | Data Network Name |
| DP | Data Plane |
| NEF | Network Exposure Function |
| NF | Network Function |
| Ng-gNB | Next Generation of gNB (6GS) |
| PDU | Protocol Data Unit |
| SMF | Session Management Function |
| UDM | Unified Data Management |
| UPF | User Plane Function |

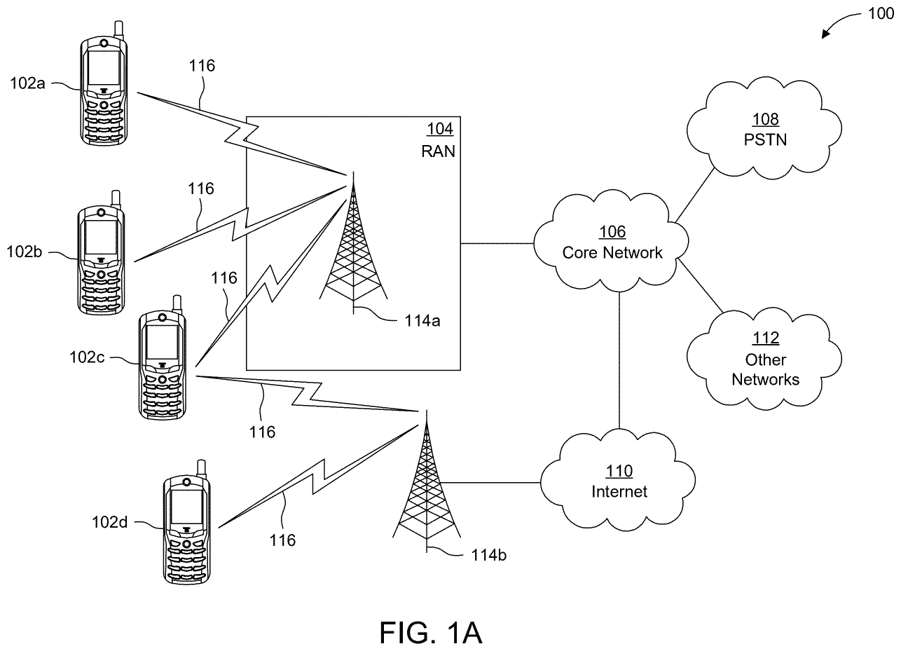

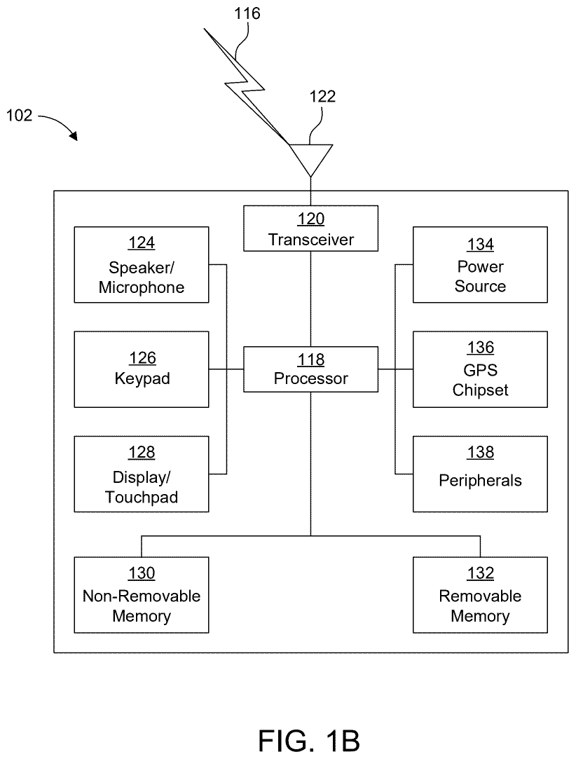

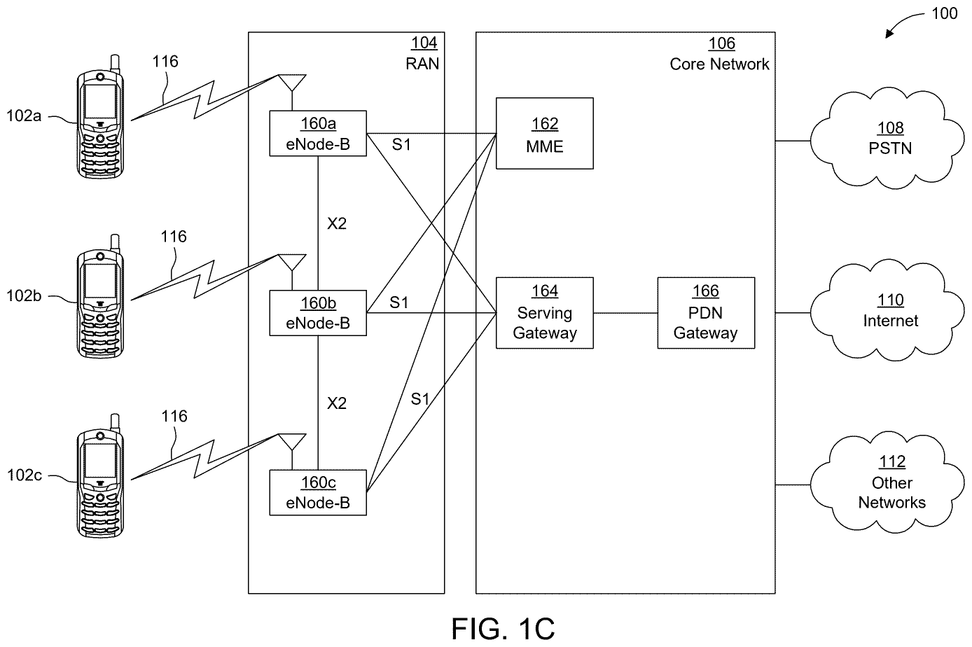

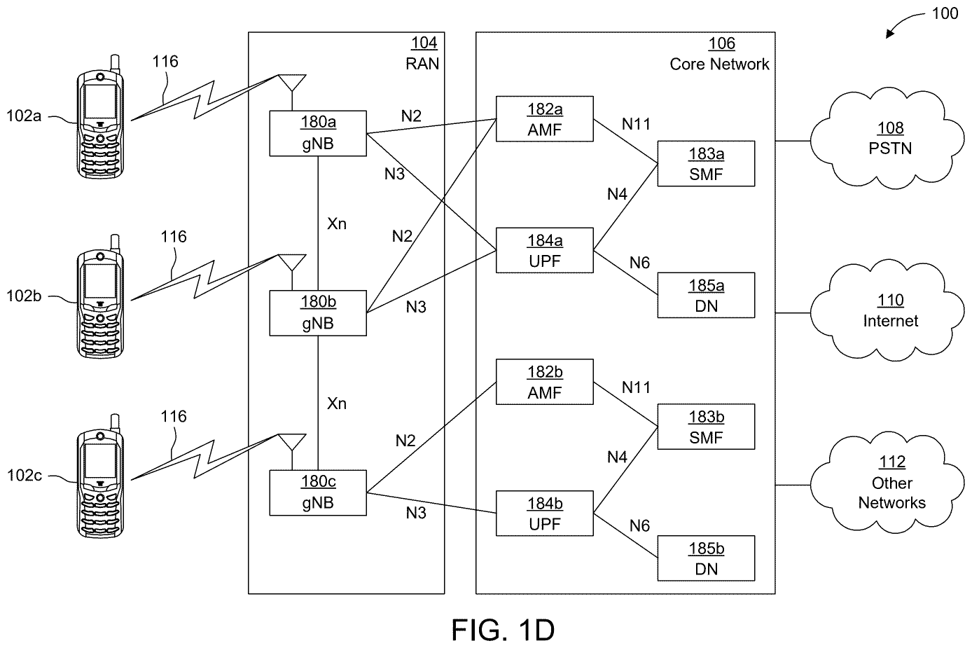

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Various embodiments, methods, systems, and/or apparatuses discussed in this disclosure relate to data plane registration and session management in a wireless communication network e.g. a sixth generation (6G) network. In non-limiting examples, the methods, systems, and/or apparatuses may also be applied in a fifth generation (5G), fourth generation (4G), and/or third generation (3G) networks.

5G network architecture evolution may enable new capabilities, both in a wireless transmit/receive unit (WTRU) and in a network. Some of the existing procedures may be enhanced and/or redefined to enable a next generation of mobile communication system, e.g. 6G.

One or more embodiments of the present disclosure provide a plane which is responsible for carrying data between the WTRU and one or more core network (CN) network functions (NFs) while a data generator and/or consumer is within a network domain and does not leaves an operators' network. For example, sensing and/or artificial intelligence (AI) and/or machine learning (ML) data exchange between the WTRU and the one or more core network functions, direct signaling (e.g. non-access stratum (NAS) signaling) between the WTRU and the one or more core network functions etc.

One or more embodiments of the present disclosure provide a functionality in the CN which is responsible for managing a data plane session. The functionality may reside in a new NF and/or an existing session management function (SMF) may be extended with the functionality wherein the SMF can handle the management of the data plane session.

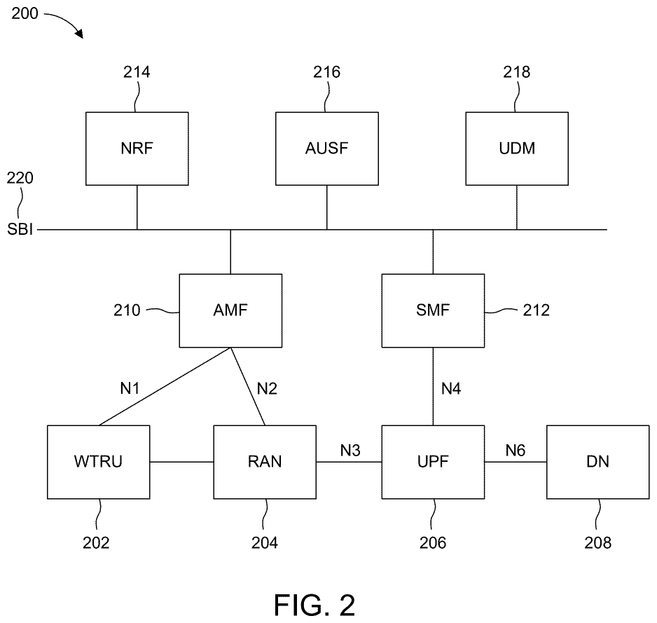

Referring now to FIG. 2, a simplified diagram of an example 5G system architecture with a subset of a plurality of NFs in a 5G core is illustrated according to one or more embodiments. FIG. 2 illustrates an example architecture 200 including a WTRU 202, a radio access network (RAN) 204, a user plane function (UPF) 206, a data network (DN) 208, an access and mobility management function (AMF) 210, an session management function (SMF) 212, a network repository function (NRF) 214, an authentication server function (AUSF) 216, and a unified data management (UDM) 218 connected by a service based interface (SBI) 220.

The NFs (e.g., the AMF 210, the SMF 212, and the UDM 218) communicate with each other using SBI 220 (using protocols like hypertext transfer protocol (HTTP) etc., for example). A goal of a service base architecture (SBA) is to enable the NFs to expose services (e.g., using RESTful application programming interfaces (APIs) etc.) to other NFs, for the 5G system to provide the desired functionality.

Typically, conventional 5G system architecture does not offer a full service based environment. While most interaction may be supported using various service based interfaces, there are some interfaces that are point-to-point interfaces between two entities. These interfaces are shown as (Nx) in FIG. 2. For example, the WTRU 202 communicates with the AMF 210 over N1 using a NAS protocol. Control plane messaging between the WTRU 202 and other NFs (e.g., the SMF 212) is done using a NAS transport encapsulation mechanism provided by the AMF 210 for the NFs.

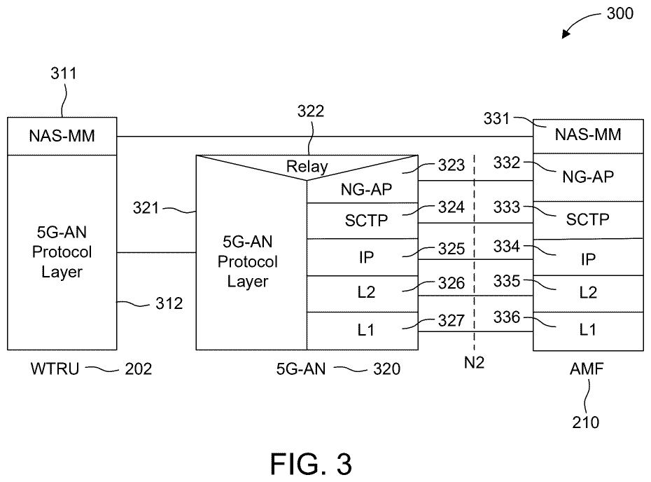

Referring now to FIG. 3, an example control plane stack between a WTRU and an AMF is illustrated according to one or more embodiments. FIG. 3 illustrates an example control plane stack 300 including a plurality of protocols used for communication between the WTRU 202 of FIG. 2, a 5G access network (AN) 320, and the AMF 210 of FIG. 2. The control plane stack 300 illustrates one or more protocols and/or the functions of the next generation wireless system, such as but not limited to 5G AN protocol layer 312 and/or NAS mobility management (NAS-MM) 311 used by the WTRU 202. The 5G AN 320 may use a 5G protocol layer 321, a relay 322, an NG-AP 323, a stream control transmission protocol (SCTP) 324, an internet protocol (IP) 325, one or more layer 2 (L2) protocols 326, and/or one or more layer 1 (L1) protocols 327. The AMF 210 may use a NAS mobility management (NAS-MM) 331, an NG-AP 332, an SCTP 333, internet protocol (IP) 334, one or more L2 protocols 335, and/or one or more L1 protocols 336.

As illustrated in FIG. 3, the RAN communicates with the AMF 210 over N2 using an NGAP protocol. The control plane messaging between WTRU 202 and the RAN access stratum (AS) is done using radio resource control (RRC) (top of the 5G-AN protocol layers) which is used to transport one or more NAS messages received or sent by RAN over N2.

A NA protocol may refer to a layer of communication protocols used between the WTRU 202 and the AMF 210 located in the CN in the 5G core. The NAS protocol operates above the AS and plays a key role in managing signaling for mobility and session management. Different mobile network functions are based on the NAS protocol.

In an example, a first function based on the NAS protocol is MM. The NAS protocol enables to manage location updates as the WTRU 202 moves between one or more tracking areas (TAs) and includes procedures like initial registration, deregistration, and/or connection management etc., for example.

In an example, a second function based on the NAS protocol is SM. The NAS protocol enables to establish, modify, and release protocol data unit (PDU) sessions for data transmission and support quality of service (QoS) management for applications.

In an example, a third function based on the NAS protocol is security management. The NAS protocol enables to provide mutual authentication between the WTRU 202 and the CN and facilitate encryption and integrity protection for one or more NAS messages.

In an example, a fourth function based on the NAS protocol is paging coordination. The NAS protocol enables re-establishing communications with the WTRU 202 when in idle mode.

In an example, a fifth function based on the NAS protocol is support for various 5G system features. The NAS protocol enables slicing support, allowing the WTRU 202 to connect to one or more specific network slices based on one or more service requirements, and enables managing dual connectivity and mobility across heterogeneous networks.

In an example, it may be appreciated that in 5G systems, the NAS protocol does not offer support for data collection and data collection session triggering or management.

In an embodiment, the NAS protocol ensures efficient and secure communication between a WTRU and a 5GC by supporting features and functions expected in 5G networks. Examples of supported functions include but are not limited to secure and encrypted communications, mobility support, session management, scalability (e.g., large number of devices), QoS differentiation, etc.

The NAS protocol may be extended to the beyond 5G networks i.e. 6G mobile wireless system with some modifications and enhancements on the WTRU side as well as on the 6G core network side.

Typically, in a conventional 5GS, there are two primary planes which are used for how the control and data signals flow through a WTRU and 5G core network i.e. control plane (CP) and user plane (UP). The CP is used for signaling between the WTRU and one or more 5G core network functions e.g. AMF, SMF, and/or PCF etc. and is responsible for authentication, registration, session management (e.g., establishment, modification, and/or release etc.), security and/or network slicing etc., for example. The UP handles actual user data traffic i.e. web browsing and/or streaming, application specific traffic, voice over internet protocol (VOIP) calls etc. between the WTRU and the external DN and is responsible for data forwarding, routing and/or QoS enforcement etc. and corresponding network function is UPF. Therefore, there is need for another plane which is responsible for carrying the data between the WTRU and the one or more core NFs while a data generator and/or consumer is within a network domain and never leaves an operator's network. For example, sensing and/or AI/ML data exchange between the WTRU and the one or more core NFs, direct signaling (e.g. NAS signaling) between the WTRU and the core NFs etc.

In an embodiment, a new plane, e.g. a data plane and/or a service plane is provided. In an example, going forward in beyond 5G networks (i.e. 6G networks), a third plane for data transport among different entities in the network may be provided.

In an embodiment, the present disclosure provides one or more methods of establishing a data plane (DP) for data exchange between a WTRU and one or more core NFs, ensuring a secure transport of data among different network actors e.g. the WTRU, the one or more core NFs such as but not limited to an AMF and/or a PCF etc., for example.

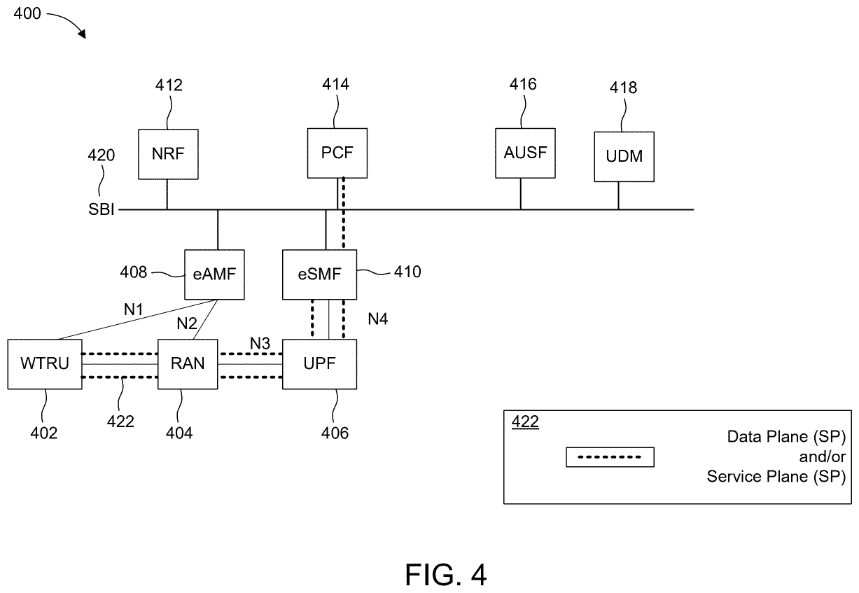

Referring now to FIG. 4, an example DP in an example 5G network is illustrated according to one or more embodiments. FIG. 4 illustrates an example 5G network 400 including a WTRU 402, a RAN node 404, a UPF 406, an enhanced AMF (eAMF) 408, an enhanced SMF (eSMF) 410, an NRF 412, a PCF 414, an AUSF 416, and a UDM 418. One or more NFs may be in communication using a SBI 420.

A 5G network architecture evolution may enable new capabilities, both in the WTRU 402 and in the 5G network 400. Some of the existing procedures may be enhanced and/or redefined to enable the next generation of the mobile communication systems.

In one or more embodiments of the present disclosure, a new plane (e.g., a DP 422 and/or a service plane (SP)) is used which is responsible for carrying the data between the WTRU 402 and the one or more core NFs while the data generator and/or consumer is within the network domain (e.g. the WTRU 402 and/or a core NF etc.), and the data generator and/or consumer never leaves the 5G network 400. For example, sensing and/or AI/ML data exchange between the WTRU 402 and the one or more core NFs, direct signaling (e.g. NAS signaling) between the WTRU 402 and the one or more core NFs etc. In an example shown in FIG. 4, the DP 422 is used for exchanging data between the WTRU 402, the RAN node 404, the UPF 406, the eSMF 410, and/or the PCF 414.

A functionality in the CN which is responsible for managing a DP session is being described with the functionality either residing in a new NF or an existing SMF is extended with the functionality wherein it can handle the management of one or more DP sessions. In an example shown in FIG. 4, the eAMF 408 and/or the eSMF 410 may be configured with the functionality for handling the management of the one or more DP sessions.

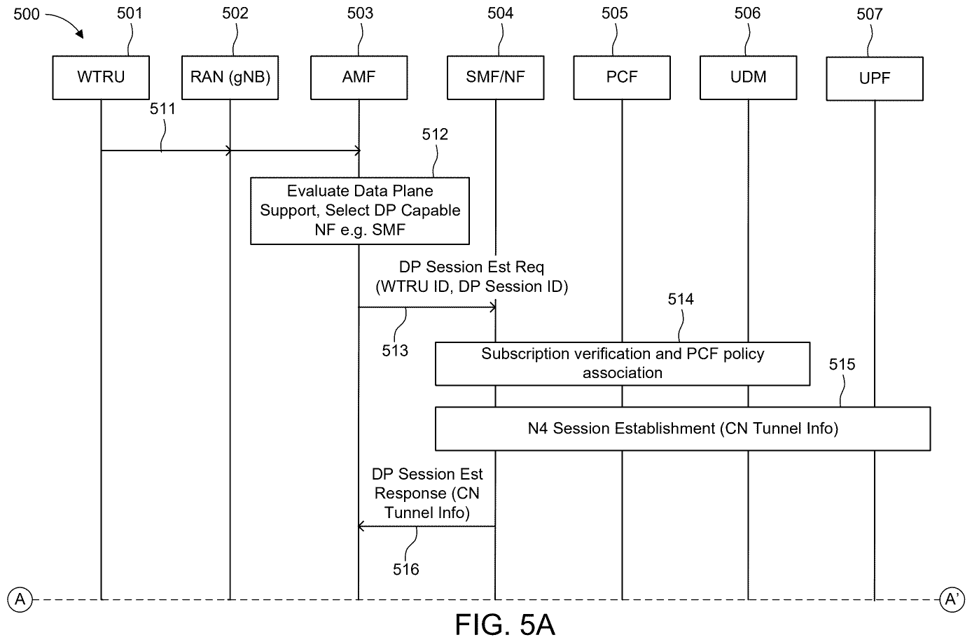

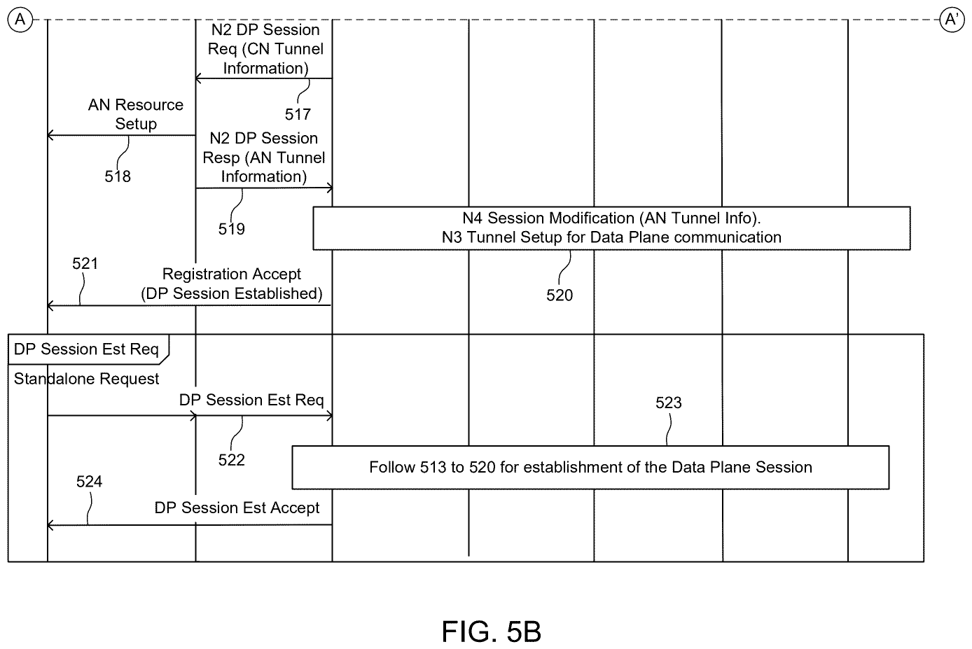

Referring now to FIGS. 5A-5B, a flow diagram illustrating an example data plane session establishment procedure is shown according to one or more embodiments. FIGS. 5A-5B illustrate an example data plane session establishment procedure 500 performed using one or more of: a WTRU 501, a RAN node 502, an AMF 503, an SMF 504, a PCF 505, a UDM 506, and/or a UPF 507. The data plane session establishment procedure 500 may be used in 5G networks and/or beyond 5G networks i.e. 6G networks etc., for example, which provide an end-to-end data plane from the WTRU 501 to a NF e.g., the SMF 504. Various core NFs described in FIGS. 5A-5B may be reused as they are and/or may have a different name and/or acronym in the 6G networks.

At 511, the WTRU 501 may trigger a registration procedure with the AMF 503 of a camped operator cell. A registration request message may include a new capability i.e. data plane support (DP support) capability, which indicates that the WTRU 501 may support the data plane functionality for data exchange between the WTRU 501 and one or more core NFs. The WTRU 501 may additionally indicate one or more services the data plane is intended to be used for e.g., sensing, AI/ML, data collection, and/or session management etc.

The WTRU 501 may be triggered by a service at the network layer and/or an application traffic that is starting and/or may be sent, and/or needs a session, and the application uses one of the services such as but not limited to sensing. In an example, the network may determine to establish a data session for the data service, like the sensing service. At the same time, the network may also prepare to setup a PDU session to carry the user plane traffic between the application traffic at the WTRU 501 and an application server.

Alternatively and/or additionally, the WTRU 501 may provide a list of network slices the WTRU 501 may be interested to use, and some of the slices may require support of data plane to be included. The core network may check if the WTRU 501 supports data plane functionality (if it hasn't been provided by the WTRU 501) for example from subscription data, and the WTRU 501 may be registered with (and/or rejected) the requested network slice based on the WTRU 501 support for data plane functionality.

At 512, the AMF 503, on reception of the registration request message from the WTRU 501 with indication of the data plane support (DP support) capability, may evaluate if a new data plane session needs to be established or not. As the message is the initial registration request message and there is no established DP session, the AMF 503 may determine and select the NF (e.g. new network function in the core network, e.g., data function which may collect, manage, process, and/or store data, and/or an enhanced existing network function e.g. the SMF 504) which may be used to establish the data plane session. Alternatively and/or additionally, the SMF 504 functionality may be extended to include the data plane session management functionality (establishment, modification, and/or release of the DP sessions etc.). The AMF 503 determination to establish the DP session may be based on one or more local configured policies in the AMF 503. The AMF 503 determination to establish the DP session may be based on an indication from the WTRU 501 in the initial registration message that indicates data plane session is required. The data plane as mentioned may be established for the WTRU 501 to be able to send data to one or multiple NFs. There may be one or multiple data sessions per WTRU 501. The selection of NFs by the AMF 503 takes into consideration indications of one or more services required by the WTRU 501 if sent in 511.

The NAS message, e.g., registration message, may include a DP message that indicates that it is destined for the purpose of data plane communication.

Alternatively and/or additionally, the registration message may include a data session management message (DSM) which may be supported in an SM container or a different container.

The AMF 503 may use this message to determine and/or select a target NF, such as the SMF 504, eSMF, and/or new NF to receive the message.

At 513, the AMF 503 may select the NF responsible for the DP session establishment (NF could be a new NF and/or the SMF 504 could be extended with the functionality to support DP sessions) and send a first DP session request (e.g., a DP session establishment request message) including a WTRU identifier (WTRU ID) and DP session ID (the session ID may be more than one if the data plane is being established for multiple services or for the WTRU 501 being able to send data to multiple NFs as per 512). To establish a new DP session, the AMF 503 may generate a new DP session ID and/or the DP session ID may be provided by the WTRU 501 during the initial registration message along with DP support indication. The AMF 503 may also provide the list of services and/or the one or more core NFs for which the data plane connection is requested by the WTRU 501. The request may also include DP session type, e.g., DP session for a particular service.

At 514, if DP session management subscription data for corresponding WTRU (i.e. subscription permanent identifier (SUPI) as WTRU identifier) is not available, then new NF and/or the enhanced SMF 504 may retrieve the DP session management subscription data from the UDM 506 (e.g. via service Nudm_SDM_Get) and may subscribe to be notified when this subscription data is modified e.g. via Nudm_SDM_Subscribe. The UDM 506 may get this information from a unified data repository (UDR) (e.g. via Nudr_DM_Query). The DP subscription data includes information e.g., a flag indicating that the WTRU is allowed to setup the DP session, one or more allowed SSC modes, a default 5QI and ARP, subscribed session-AMBR etc. The new NF and/or the SMF 504 may check the validity of the WTRU 501 and/or the AMF request to setup the DP session, e.g. whether the WTRU request is compliant with the user subscription data and with the one or more local policies. If the WTRU request is considered as not valid, the new NF and/or the SMF may reject the request to establish the DP session. The new NF and/or the SMF 504 may establish a policy association with the PCF 505 and derive one or more policy and charging control (PCC) rules for controlling service data flows (e.g., IP and/or packet filters), enforcing QoS (e.g. QoS flow identifier, QoS characteristics like guaranteed bit rate (GBR), aggregate maximum bit rate (AMBR), packet delay budget (PDB), allocation and retention priority (ARP) etc.) and applying one or more charging policies e.g. online and/or offline charging (if DP traffic may be charged in real time and/or after usage), other rules to allow and/or block traffic, time and/or location validity information applicability to the DP traffic. Subscription information per requested service and/or NF may also obtained from the UDM 506.

In an example, one or more parameters in the one or more PCC rules, such as one or more QoS related parameters and so on, may be determined based on one or more characteristics of the service that the data session is carrying. For example, for a critical data collection service where high data accuracy is needed, the data rate to be allocated to the QoS flow or data session for the WTRU 501 may be high as more data volume is needed in a short time. Some of these characteristics and/or parameters may be communicated between the WTRU 501 and the network system, to configure the service of interest. For example, for a location service or sensing service, if there is a network function that hosts sensing management functionality, then some parameters related to how the sensing service is to be configured may be used to determine the one or more QoS parameters of the data session carrying the data in the data plane.

At 515, the new NF and/or the SMF 504 may initiate a N4 session establishment procedure with the UPF 507 for the data plane session traffic. The new NF and/or the SMF 504 may send an N4 session establishment request to the UPF 507 and provide packet detection, enforcement and reporting rules to be installed on the UPF 507 for this DP session. The reporting rules may indicate that the UPF 507 sends the received data for the data session to the SMF 504 or to another network function such as a location management function (LMF) and/or a network data analytics function (NWDAF) and/or a data collection function. The UPF 507 acknowledges by sending a N4 session establishment response. If the new NF and/or the SMF 504 indicates in 514 that IP address and/or prefix allocation is to be performed by the UPF 507 then this response includes the requested IP address and/or prefix along within the CN tunnel information. The CN tunnel information corresponds to one or more core network addresses of the N3 tunnel corresponding to the DP session, the N3 tunnel is between the RAN node 502 and the UPF 507 for carrying the data plane traffic between the WTRU 501 and the one or more core NFs. The UPF 507 may be configured with the destination IP address, a fully qualified domain name (FQDN), a mapped address (mapping of the destination address to address sent to the WTRU 501) for the one or more NFs.

At 516, the new NF and/or the SMF 504 may respond to the DP session establishment response including N2 DP information for the RAN node 502 configuration. In that, the AMF may receive a first DP session response (e.g., the DP session establishment response) including the N2 DP information. The N2 DP information includes information that the AMF 503 may forward to the RAN node 502 and may include the DP session ID, one or more QoS profiles, one or more QoS flow IDs (QFIs) and CN tunnel information. The AMF 503 may also receive the FQDN, the destination IP address, one or more mapped address of the one or more NFs.

At 517, the AMF 503 may send a second DP session request (e.g., a N2 DP session request) to the RAN node (gNB) 502 including the N2 DP information that the AMF 503 received from the new NF and/or the SMF 504.

At 518, the gNB (e.g., the RAN node 502) may trigger the AN specific signaling exchange with the WTRU 501 on reception of the N2 DP session request from the SMF 504. For example, in the case of a NG-RAN, an RRC connection reconfiguration may take place with the WTRU 501 establishing one or more necessary NG-RAN resources related to one or more QoS rules for the DP session. For example, one or more special radio bearers are established between the WTRU 501 and the RAN node 502 to carry out the data plane traffic. The gNB (e.g., the RAN node 502) also allocates AN tunnel information for the DP session. The AN tunnel information includes a tunnel endpoint for the RAN node 502 and one or more assigned QFIs.

At 519, the RAN node 502 (e.g., the gNB) may respond with the N2 DP session response including the N2 DP information which may include the DP session ID, the AN tunnel information, a list of accepted and/or rejected QFIs. In that, the AMF receives, from the RAN node, a second DP session response (e.g., the N2 DP session response) including the AN tunnel information. The AN tunnel information corresponds to an access network address of the N3 tunnel corresponding to the DP session.

At 520, the AMF 503 may forward the N2 DP information received from the gNB to the new NF and/or the SMF 504. The new NF and/or SMF 504 initiates an N4 DP session modification procedure with the UPF 507. The SMF 504 provides the AN tunnel information received from the gNB to the UPF 507. The UPF 507 provides an N4 session modification response to the SMF 504. After 520, the data plane link is established between the WTRU 501 and the one or more core NFs.

At 521, the AMF 503 may respond to the WTRU 501 with the registration accept message including details of the established DP session which may include the one or more QoS rules and/or parameters, one or more allocated IP addresses, the GBR and/or AMBR information, one or more policies for routing information (e.g. similar to the WTRU route selection policies (URSP) etc.) for various core network functions. The AMF 503 may also send a data network name (DNN) of the data plane and any restrictions associated with the DNN e.g. location etc. The one or more routing policies may contain information which is used by the WTRU 501 to determine how to route the data plane traffic to one or more specific NFs in the CN. The one or more routing policies may include rules e.g. NF identifier (e.g. the SMF 504, the PCF 505, and/or a data storage function etc.), one or more destination IP address, one or more destination port numbers and/or one or more mapped destination address and/or port numbers, the FQDN etc. This information may be sent per service and/or NF the data plane may be used by the WTRU 501 to send data to. The WTRU 501 may apply the one or more rules for traffic matching and/or routing i.e. which traffic flows should be sent over which network slice, data path (the one or more destination IP address and/or port numbers etc.) and over existing and/or new DP session is needed. The registration accept message informs the WTRU 501 which services and/or NFs are accessible for the data transfer. In the scenario, when the data plane is not established for a requested service in 511, a cause code indication the reason unsuccessful case is sent to the WTRU 501 by the AMF 503.

In an embodiment, 513-520 may not be executed at the time of registration procedure. A procedure similar to PDU session establishment after registration may be triggered by the WTRU 501 to establish the data plane connection. The WTRU 501 may use the one or more parameters received in 521 to start the data plane session establishment procedure as described herein below.

At 522, in the scenario where the data plane session is not established during the registration procedure and/or the WTRU 501 is not configured to establish the DP session by default during the registration procedure, the WTRU 501 may request explicit DP session establishment via sending DP session establishment request message to the AMF 503, to be directed for the new NF and/or the SMF 504 for DP session establishment.

At 523, one or more procedures in 513-520 may be performed for the establishment of the DP session.

At 524, the AMF 503 responds back to the WTRU 501 with DP session establishment accept message including details about the established DP session, for example, similar to 521.

In an example, where the data plane session may have not been established during the registration procedure, a network triggered data session procedure may take place. For example, for a service such as data collection, if used for the purpose for training one or more ML models for analytics to be used by a NWDAF NF, then if there performance of some analytics IDs of interest has deteriorated, due to decreased accuracy, then the NWDAF may request from a network function like the SMF 504 and/or the PCF 505 and/or other NF, for example, that data collection form the WTRU 501 is needed. This may trigger the network, e.g., via the SMF 504, the eSMF, and/or the new NF, to send a network triggered data plane session procedure with the WTRU 501 to setup a data plane session between the WTRU 501 and the CN for the purpose of collecting the relevant data for the NWDAF.

In an embodiment, one or more methods implemented by the WTRU are also provided. The WTRU may send, to the network, the registration request including one or more new indications and capabilities, including but not limited to one or more of: a flag to establish a data plane, a DNN, data plane establishment during registration procedure, request for one or more data plane parameters, one or more services that the data plane may be used for (e.g. sensing, AI/ML, SM, location etc.). The WTRU may receive, from the network, a confirmation of establishment of the data plane (e.g., may be special bearer established on the RAN side, packet filters per service, one or more policies for routing traffic and the type of traffic, source IP address (e.g., may be non-IP or some other source address), a FQDN, a mapped address and/or destination address of the NFs (e.g. SF, data collection function, SMF etc.) that the WTRU may reach through the data plane. In an example, if the data plane is not established during the registration procedure, the WTRU may receive one or more parameters e.g. DNN, single-network slice selection assistance information (S-NSSAI), QoS information, type (IP and/or non IP) etc. to establish a session, (e.g. a PDU session) for the data plane in the registration accept message.

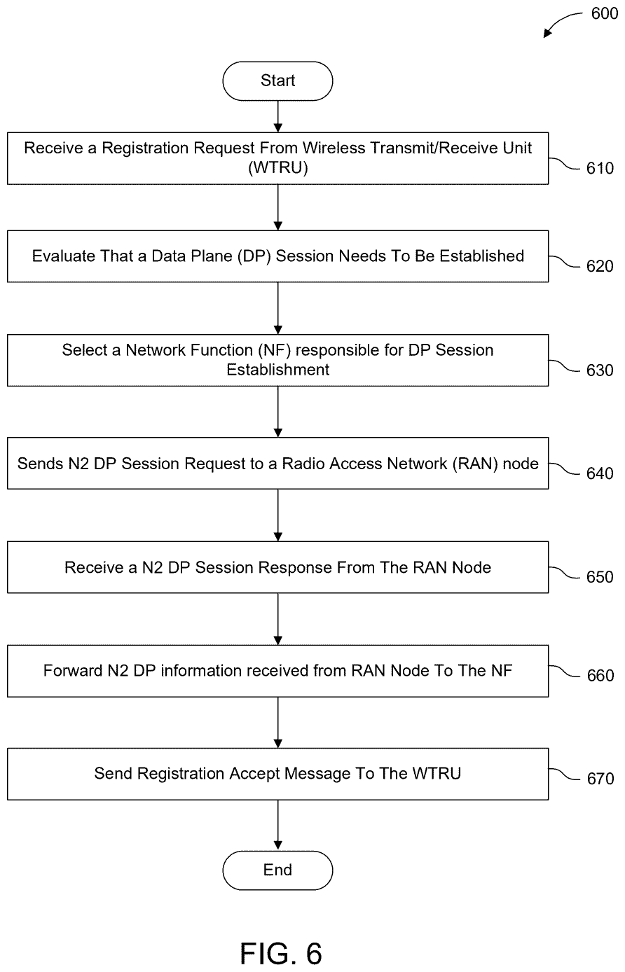

Referring now to FIG. 6, a flowchart illustrating an example process of establishing a DP session is shown according to one or more embodiments. FIG. 6 shows an example process 600 that can be performed by a network node such as an AMF.

At 610, the AMF may receive a registration request from a WTRU including a new capability indication i.e. DP support capability which indicates that the WTRU supports the DP functionality for data exchange between the WTRU and one or more core NFs. The registration request is indicative of one or more of: a DP message, a DSM, or one or more services requested by the WTRU.

At 620, the AMF may select a NF based on the registration request. In that, the AMF, on reception of the registration request message from the WTRU with the indication of the DP support capability, may evaluate if a new DP session needs to be established or not. As the message is the initial registration request message and there is no established DP session, the AMF may determine and select the NF (e.g. a new NF in the CN and/or an enhanced existing network function e.g. an enhanced SMF) which may be used to establish the DP session. In an example, the SMF functionality may be extended to include DP session management functionality (e.g., establishment, modification, and/or release of the DP sessions). The AMF determination to establish the DP session may be based on one or more local configured policies in the AMF.

In an example, the AMF may determine, based on DP session management subscription data associated with the WTRU, whether the registration request is valid. The NF may be selected on a condition that the registration request is valid. The AMF may, on a condition that the registration request is not valid, transmit a registration reject message to the WTRU. In an example, the AMF may receiving the DP session management subscription data from the WTRU and/or retrieve the DP session management subscription data from a second NF, e.g., a UDM.

At 630, the AMF may select the NF responsible for the DP session establishment (e.g., the NF may be a new NF and/or an SMF may be extended with the functionality to support one or more DP sessions) and send DP session establishment request message with a WTRU identifier (WTRU ID) associated with the WTRU and a DP session ID associated with the DP session. For establishing a new DP session, the AMF may generate a new DP session ID and/or the DP Session ID may be provided by the WTRU during the initial registration message along with the DP support indication. The new NF and/or the SMF may respond to the DP session establishment response including N2 DP information for the RAN node configuration. The N2 DP information includes information that the AMF may forward to the RAN node and may include the DP session ID, one or more QoS profiles, one or more QFIs and CN tunnel information. The DP session establishment response includes CN tunnel information including a CN address of a tunnel between the NF and a RAN node.

At 640, the AMF may send the N2 DP session request to the RAN node (e.g., a gNB) including the N2 DP information (e.g., including the CN tunnel information) that the AMF received from the new NF and/or the SMF.

At 650, the RAN node (e.g., the gNB) may respond with the N2 DP session response including the N2 DP information which may include the DP session ID, AN tunnel information, a list of one or more accepted and/or rejected QFIs. The AN tunnel information corresponds to an AN address of an N3 tunnel corresponding to the DP session. In that, the AMF may receive the N2 DP session response from the RAN node. The AN tunnel information includes a tunnel endpoint identifier associated with the RAN node.

At 660, the AMF may forward the N2 DP information received from the RAN node (e.g. the gNB) to the new NF and/or the SMF. The new NF and/or the SMF may initiate an N4 DP session modification procedure with the UPF. The SMF may provide the AN tunnel information received from the gNB to the UPF. The UPF may provide an N4 session modification response to the SMF. After this, a data plane link may be established between the WTRU and the one or more CN functions.

At 670, the AMF may respond to the WTRU with the registration accept message indicative of establishing the DP session. The registration accept message may include details of the established DP session which may include one or more QoS rules and/or parameters, an allocated IP address, GBR and/or AMBR information, one or more policies for routing information (e.g. similar to one or more URSPs) for various core NFs. The one or more routing policies may include information which is used by the WTRU to determine how to route the data plane traffic to one or more specific NFs in the CN. The one or more routing policies may include rules e.g. an NF identifier (e.g. SMF, PCF, and/or data storage function etc.), a destination IP address, one or more destination port numbers and/or mapped destination IP address and/or port numbers, a FQDN etc. The WTRU may apply these rules for traffic matching and routing i.e. which traffic flows should be sent over which network slice, data path (destination IP address and/or port numbers) over existing and/or new DP session is needed.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method comprising:
receiving, from a wireless transmit/receive unit (WTRU), a registration request indicative of a data plane (DP) support capability;
selecting a network function (NF) based on the registration request;
transmitting, to the NF, a first DP session request including a WTRU identifier (ID) associated with the WTRU and a DP session ID associated with a DP session;
receiving, from the NF, a first DP session response including core network (CN) tunnel information;
transmitting, to a radio access network (RAN) node, a second DP session request including the CN tunnel information;
receiving, from the RAN node, a second DP session response including access network (AN) tunnel information; and
forwarding the AN tunnel information to the NF.

2. The method of claim 1, wherein determining the establishment of a DP session is based on one or more policies.

3. The method of claim 1, further comprising:
generating the DP session ID based on the registration request.

4. The method of claim 1, wherein the registration request is indicative of one or more of:
a DP message,
a data session management message (DSM), or
one or more services requested by the WTRU.

5. The method of claim 1, further comprising:
transmitting, to the WTRU, a registration accept message indicative of establishing the DP session.

6. The method of claim 1, wherein the CN tunnel information includes a CN address of a tunnel between the NF and the RAN node.

7. The method of claim 1, wherein the AN tunnel information includes a tunnel endpoint identifier associated with the RAN node.

8. The method of claim 1, further comprising:
determining, based on DP session management subscription data associated with the WTRU, whether the registration request is valid, wherein the NF is selected on a condition that the registration request is valid; and
on a condition that the registration request is not valid, transmitting a registration reject message to the WTRU.

9. The method of claim 8, further comprising:
receiving the DP session management subscription data from the WTRU or a second NF.

10. The method of claim 1, wherein the method is performed by an access and mobility management function (AMF).

11. An apparatus, comprising:
a transceiver; and
a processor, wherein the transceiver and the processor are configured to:
receive, from a wireless transmit/receive unit (WTRU), a registration request indicative of a data plane (DP) support capability;
select a network function (NF) based on the registration request;
transmit, to the NF, a first DP session request including a WTRU identifier (ID) associated with the WTRU and a DP session ID associated with a DP session;
receive, from the NF, a first DP session response including core network (CN) tunnel information;
transmit, to a radio access network (RAN) node, a second DP session request including the CN tunnel information;
receive, from the RAN node, a second DP session response including access network (AN) tunnel information; and
forward the AN tunnel information to the NF.

12. The apparatus of claim 11, wherein determining the establishment of a DP session is based on one or more policies.

13. The apparatus of claim 11, wherein the transceiver and the processor are further configured to:
generate the DP session ID based on the registration request.

14. The apparatus of claim 11, wherein the registration request is indicative of one or more of:
a DP message,
a data session management message (DSM), or
one or more services requested by the WTRU.

15. The apparatus of claim 11, wherein the transceiver and the processor are further configured to:
transmit, to the WTRU, a registration accept message indicative of establishing the DP session.

16. The apparatus of claim 11, wherein the CN tunnel information includes a CN address of a tunnel between the NF and the RAN node.

17. The apparatus of claim 11, wherein the AN tunnel information includes a tunnel endpoint identifier associated with the RAN node.

18. The apparatus of claim 11, wherein the transceiver and the processor are further configured to:
determine, based on DP session management subscription data associated with the WTRU, whether the registration request is valid, wherein the NF is selected on a condition that the registration request is valid; and
on a condition that the registration request is not valid, transmit a registration reject message to the WTRU.

19. The apparatus of claim 18, wherein the transceiver and the processor are further configured to:
receive the DP session management subscription data from the WTRU or a second NF.

20. The apparatus of claim 19, wherein the apparatus is an access and mobility management function (AMF).
